(19) United States
(12) Patent Application Publication
(10) Pub. No.: US 2017/0340103 A1
(43) Pub. Date: Nov. 30, 2017

(54) DEVICE FOR ADJUSTING THE HEIGHT OF A FIRST PART RELATIVE TO A SECOND PART, A RETROFIT KIT FOR SUCH A DEVICE AND HEIGHT-ADJUSTABLE SYSTEM COMPRISING A PLURALITY OF SUCH DEVICES

(71) Applicant: SUSPA GmbH, Altdorf (DE)

(72) Inventors: Markus HAPPICH, Feucht-Moosbach (DE); Joel Zifried KENGNI, Nürnberg (DE); Sebastian SCHMITT, Nürnberg (DE)

(21) Appl. No.: 15/521,078

(22) PCT Filed: Oct. 23, 2015
(86) PCT No.: PCT/EP2015/074559

§ 371 Date: Apr. 21, 2017

(30) Foreign Application Priority Data
Oct. 24, 2014 (DE) 10 2014 221 699.0

(51) Int. Cl. A47B 9/04; B66F 3/44; F16H 3/06; A47B 9/20; F16H 29/08; F16H 27/02

(52) U.S. Cl. CPC A47B 9/04; F16H 29/08; F16H 27/02; F16H 3/06; A47B 9/20; B66F 3/44; A47B 2009/046; A47B 2200/0059

(57) ABSTRACT

A device for adjusting the height of a first part relative to a second part includes a first hollow profiled element, a second hollow profiled element which is displaceable along its longitudinal axis relative to the first hollow profiled element, a drive unit for displacement of the second hollow profiled element relative to the first hollow profiled element and a support unit which, in relation to the longitudinal axis, is arranged between the first hollow profiled element and the second hollow profiled element for the purpose of supporting the first hollow profiled element against the second hollow profiled element.

### CROSS REFERENCE TO RELATED APPLICATIONS

This application is a United States National Phase application of International Application PCT/EP2015/074559 filed Oct. 23, 2015 and claims the benefit of priority under 35 U.S.C. §119 of German patent application 10 2014 221 699.0 filed Oct. 24, 2014, the entire contents of which are incorporated herein by reference.

### FIELD OF THE INVENTION

The invention relates to a device for adjusting the height of a first part relative to a second part, a retrofit kit for such a device and also a height-adjustable system comprising a plurality of such devices.

### BACKGROUND OF THE INVENTION

Height-adjustable systems with hydraulic cylinders which are controlled by a common pump are known in the art. These height-adjustable systems are suitable for moving heavy loads at high movement speeds. The hydraulic cylinders work actively in an extension direction. In an opposite retraction direction, a counteracting force is required for displacement. Hydraulic fluid escaping from hose lines and/or the hydraulic cylinders due to damage to the system, for example, is undesirable in principle, can cause damage and ultimately lead to a system failure and is not permitted in operational areas where hygiene is an issue in catering and medical engineering, for example. In order to guarantee the tightness of the system over its entire service life and a working temperature range, a high degree of expenditure is required, particularly during manufacture.

DE 10 2010 000 970 A1 discloses a device for table height adjustment by means of an electric motor. A device of this kind is restricted in application, as the movable loads are limited and can only be integrated into existing systems with some difficulty on account of the relatively large installation sizes.

The problem addressed by the present invention is that of providing a height-adjustment device which can manage heavy loads and makes hydraulic cylinders and the disadvantages associated with these unnecessary.

### SUMMARY OF THE INVENTION

The problem is solved by a device for adjusting the height of a first part relative to a second part, wherein the device comprises a first hollow profiled element, a second hollow profiled element which is displaceable along its longitudinal axis relative to the first hollow profiled element, a drive unit for displacement of the second hollow profiled element relative to the first hollow profiled element, and a support unit for supporting the first hollow profiled element against the second hollow profiled element, the support unit being arranged between the first hollow profiled element and the second hollow profiled element relative to the longitudinal axis, by a retrofit kit for a device according to the invention comprising a drive unit that can be arranged in the first hollow profiled element and/or in the second hollow profiled element for displacing the second hollow profiled element relative to the first hollow profiled element and a support unit that can be arranged between the first hollow profiled element and the second hollow profiled element relative to the longitudinal axis, and by a height-adjustable system comprising at least a first part, at least a second part height-adjustable relative to the first part, at least one device according to the invention for height adjustment of a first part in each case relative to a second part in each case, wherein the first hollow profiled element of a device is connected to the first part, wherein the second hollow profiled element of a device is connected to the second part. The crucial point of the invention is that a device for height adjustment has two hollow profiled elements which are displaceable relative to one another, wherein a support unit arranged between the hollow profiled elements relative to the longitudinal axis thereof is provided. The support unit is used to support the first hollow profiled element against the second hollow profiled element. The first hollow profiled element is, in particular, arranged within the second outer hollow profiled element. The first inner hollow profiled element rests with an outer side against an inner side of the support unit. The support unit enables exposure to a radial and/or transverse force by the first hollow profiled element to be absorbed. In particular, the first hollow profiled element rests with the outer side against the inner face of the outer hollow profiled element. The support unit lies in particular with an outer side on an inner side of the external hollow profiled element. In particular, a planar contact is provided between the respective hollow profiled element and the support unit. The relative displacement between the hollow profiled elements is stabilized and robust. A drive unit that allows a displacement of the two hollow profiled elements relative to one another makes a hydraulic cylinder unnecessary. Other drive concepts, particularly independent of the hydraulic system, are possible. The disadvantages of a hydraulic adjustment system are thereby avoided. Due to the support involving the support unit, the alternative drive concepts facilitate the displacement of large loads which could only have been displaced by means of a hydraulic adjustment system, for example. Along the longitudinal axis an axial force of at least 1 kN, in particular at least 1.2 kN, in particular at least 1.4 kN and in particular at least 1.5 kN can be overcome using the device, for example.

A device in which the drive unit comprises a motor, in particular an electric motor, allows an advantageous displacement of the hollow profiled elements relative to one another. An electric motor is easily electrically controllable. An electric motor may be of compact design and, in particular, integrated within a hollow profiled element. Attachment via an electrical connection plug and cable is easily possible. The speed and torque of the electric motor may be prefabricated within broad limits. There is a large choice of electric motors.

A device in which the drive unit has a gear allows adjustment of the speed and torque of a motor for the drive unit. A gear may, in particular, increase the torque and therefore the propulsive force of the device.

A device in which the drive unit has a threaded spindle and a spindle nut corresponding thereto allows a robust and precise displacement of the hollow profiled elements relative to one another. The threaded spindle is, in particular, arranged within the second hollow profiled element and fixedly connected to the second hollow profiled element, particularly in relation to a displacement along the longitudinal axis. A rotational movement of the threaded spindle causes an axial displacement of the spindle nut, particularly relative to the second hollow profiled element.

A device with a brake unit makes it possible, in particular, for there to be an accidental displacement of the hollow profiled elements towards one another, particularly without actuation of the drive unit. In order to facilitate higher movement speeds using the drive unit too and also keep the spindle speed low during this on account of noise generation, a spindle drive may be provided in which the threaded spindle exhibits a spindle pitch of such a size that a self-locking effect is not guaranteed. Loads which are to be moved can be displaced, in particular raised, using the device. When the drive unit is in a non-actuated state, however, it cannot be reliably guaranteed that a previously moved load can be held in the non-actuated state. Due to the loading of the external load and the limited or non-existent self-locking of the threaded spindle, there could be an unwanted insertion displacement. In order to prevent this, the braking unit is provided. The braking unit is active particularly in a manner dependent on the rotational direction. This means that depending on the rotational direction of the drive unit, in particular of the threaded spindle, a braking action develops. It is advantageous for the brake unit to exhibit a braking action when the device is retracted, in other words during a rotational retraction movement. In the opposite rotational direction, in other words an extension rotational direction, no or only a significantly reduced braking action should be generated. In particular, the brake unit should therefore be configured in such a manner that an extension displacement for lifting a load takes place without or with a significantly smaller braking action. An insertion displacement which results particularly through actuation of the drive unit, particularly of the threaded spindle, along an insertion rotational direction, is slowed down. The braking unit may, in particular, be configured as a coil-spring brake or as a brake with a freewheel.

A device with anti-twist protection to prevent the second hollow profiled element from twisting relative to the first hollow profiled element about the longitudinal axis guarantees a reliable conversion of a rotational movement of a kinematic unit, in particular the threaded spindle, into an axial displacement of the hollow profiled elements along the longitudinal axis. The threaded spindle, in particular, is guided in a displaceable manner along the longitudinal axis of the device.

A device in which the anti-twist protection has a member which is displaceable along the longitudinal axis, in particular a spindle nut with an out-of-center member contour perpendicular to the longitudinal axis, wherein the displaceable member interacts particularly with a holding structure which exhibits a holding structure contour corresponding to the member contour, the anti-twist protection is robust and uncomplicated in design. It is advantageous for the displaceable member to be, in particular, the spindle nut of the drive unit. The spindle nut is used in the kinematic unit to convert the rotational drive movement into an axial displacement. At the same time, the spindle nut is used for guided axial displacement and therefore as anti-twist protection. The member contour is, in particular, designed as the outer contour on the spindle nut. In particular, the holding structure contour is designed as the inner contour and, in particular, the holding structure contour on the outer hollow profiled element is integrated.

A device in which the member contour exhibits at least one, in particular at least two, in particular at least three and in particular exactly three, radially projecting guide bars relative to the longitudinal axis and the holding structure contour exhibits a guide groove corresponding to the at least one guide bar, enables the anti-twist protection to be of compact design.

A device in which the support unit has a guide bushing which is fastened, particularly at the face end, to the second hollow profiled element, facilitates an uncomplicated and robustly designed support particularly of the first hollow profiled element.

A device in which the support unit acts as an axial stop member for displacement of the first hollow profiled element relative to the second hollow profiled element guarantees a defined displacement of the hollow profiled elements relative to one another. A separate stop member in particular which restricts the maximum extension movement of the device is not required. The support unit is of functionally integrated design.

A device with an encoder unit, particularly for electrical connection of the drive unit, simplifies the accessibility and control of the drive unit. The encoder unit particularly simplifies the supply of electrical current to the drive unit and, moreover, particularly detection of the rotational direction and number of rotations performed by the drive unit.

A device with a storage unit for absorbing forces directed radially and/or axially relative to the longitudinal axis which have particularly been introduced by the drive unit allow a stable and robust configuration of the device. The device is suitable for absorbing forces directed radially and/or axially from outside. Forces of this kind from outside do not impede the function of the device.

A retrofit kit for a device according to the invention enables a device according to the invention to be retrofitted to an existing height adjustment system. A retrofit kit comprises a drive unit that can be arranged in the first and/or second hollow profiled element for displacing the second hollow profiled element relative to the first hollow profiled element. The retrofit kit further comprises a support unit that can be arranged between the first hollow profiled element and the second hollow profiled element relative to the longitudinal axis. The retrofit kit particularly allows existing height adjustment systems which are attached to hydraulic cylinders to be replaced with alternative drive units, in particular drive units driven by electric motors. The fact that the retrofit kit of the device exhibits a support unit means that a stabilized displacement of the hollow profiled elements relative to one another is possible. It is therefore guaranteed that the installation space available within the hollow profile elements of an originally hydraulic cylinder-attached height adjustment system is sufficient to accommodate a corresponding retrofit kit therein, in particular the drive unit and the support unit. In particular, the retrofit kit allows hollow profiled elements to be used which are structurally identical to the hollow profiled elements of existing height-adjustable systems. When retrofitting a height-adjustable system, it is particularly sufficient for the hydraulic-based devices to be exchanged for devices according to the invention. An existing static system which is not height-adjustable may be equipped with the retrofit kit, in order to create a height-adjustable system. The retrofit kit allows a functional enhancement of functional furniture.

A height-adjustable system having at least a first part, in particular a castor, having at least a second part height-adjustable relative to the first part and at least a device according to the invention substantially exhibits the advantages of the device according to the invention itself, to which reference is made here. The height-adjustable system particularly comprises at least three and, in particular, exactly four devices, wherein the first inner hollow profiled element of the device in each case is connected to at least a first part in each case. The second inner hollow profiled element of a device in each case is, in particular, connected to a part of a basic structure of a table or another basic lifting application. Part of a basic structure of the table or another lifting application is, in particular, a table leg. The table legs may be connected to one another via reinforcement members and/or via a shared table top. The basic structure in particular forms the substructure of a table top or a device support. By means of the devices, the castors can be displaced relative to the basic structure of the table or the lifting application. A table or another lifting application which is supported via the basic structure, the devices connected thereto and the castors attached thereto on the base, can be height-adjusted through actuation of the devices. Actuation of the devices also causes a lifting of the basic structure of the table or the lifting application with the table top or device support attached thereto.

A height-adjustable system with at least a first part, in particular a castor, having at least a second part height-adjustable relative to the first part and at least one device according to the invention, substantially exhibits the advantages of the device according to the invention, to which reference is made here. The height-adjustable system particularly comprises at least three and, in particular, precisely four devices, wherein the first, inner hollow profiled element of the device in each case is connected to a first part. The second, inner hollow profiled element of a device is connected in each case to the second part, in particular a part of a basic structure of a table or another basic lifting application. Part of a basic structure of the table or another lifting application is, in particular, a table leg. The table legs may be connected to one another via reinforcement members and/or via a common table top. The basic structure particularly forms the substructure of a table top or device support. By means of the devices, the castors can be displaced relative to the basic structure of the table or the lifting application which is supported on the ground via the basic structure, the devices connected thereto and the castors attached thereto on the ground. Actuation of the devices therefore brings about a lifting of the basic structure of the table or the lifting application with the table top or device support attached thereto.

A height-adjustable system with a control unit for controlling the drive units allows a linear height adjustment of the system. In particular, the control unit is used for synchronizing the drive units. Synchronization is particularly necessary when the individual drive units are unevenly loaded, particularly as a result of external loading. It is guaranteed that despite uneven loading of the drive units, all drive units are extended uniformly, in other words at the same displacement speed.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a height-adjustable system according to the invention;

FIG. 2 is an enlarged view of a device for height adjustment in a retracted arrangement;

FIG. 3 is a view of the device corresponding to FIG. 2 in an extended arrangement;

FIG. 4 is an enlarged detail view of a sectional representation according to detail IV in FIG. 2;

FIG. 5 is an enlarged detail view of a sectional representation according to detail V in FIG. 2;

FIG. 6 is a view of detail VI in FIG. 3 corresponding to FIG. 5;

FIG. 7 is a sectional view according to the line of intersection VII-VII in FIG. 5;

FIG. 8 is an enlarged detail view of the detail VIII in FIG. 5 for representation of a brake unit according to a first exemplary embodiment; and

FIG. 9 is a view corresponding to FIG. 8 of a brake unit according to a second exemplary embodiment.

### DESCRIPTION OF THE PREFERRED EMBODIMENTS

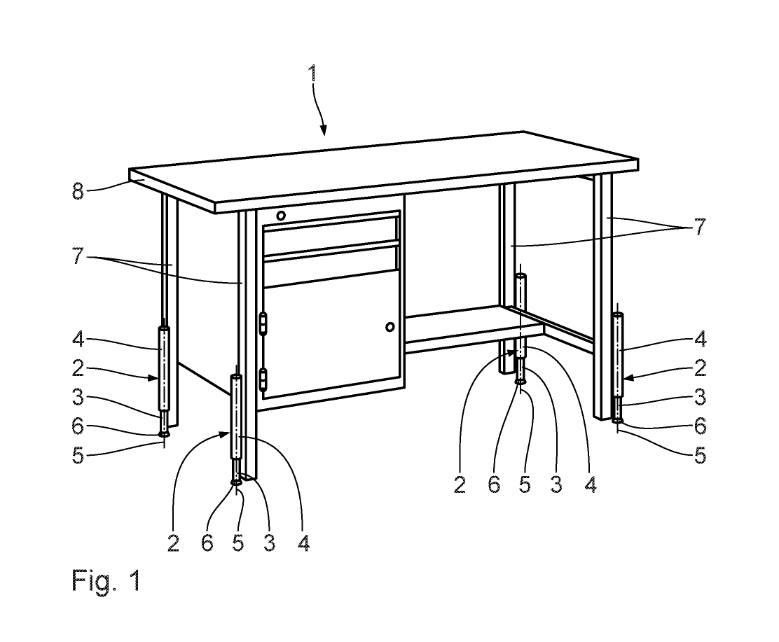

A height-adjustable system 1 depicted in FIG. 1 is implemented in the form of a height-adjustable workbench. The system 1 is a height-adjustable table which can be used in principle in various fields of application. In an industrial context, height-adjustable systems according to the invention in the form of height-adjustable conveyor belts, assembly belts, assembly systems and/or machines are conceivable. In the furniture business, height-adjustable kitchen islands, washbasins, work surfaces and other kitchen furniture are conceivable for kitchen applications. An office work station may, for example, be an individual height-adjustable work station. Height-adjustable group work stations, particularly in the form of office desks, drawing boards, CAD workstations, sewing and packing tables and sink units in catering are also conceivable. Commercially used furniture is known in the art such as, for example, height-adjustable sales and/or service facilities in the wholesale and retail trade, in particular bargain tables, height-adjustable display windows in museums and exhibition spaces and, in particular, points of sale, sales counters, check-in desks. Height-adjustable patient beds are used in the field of medical and rehabilitation technology, in order to allow safe and comfortable raising and lowering. There are height-adjustable treatment tables, operating tables and massage beds. A height-adjustable system within the meaning of the invention may also be conceivable, particularly in a bathtub. Height-adjustable incubators and/or autopsy tables are conceivable.

The height-adjustable system 1 comprises four devices 2 for height adjustments. The devices 2 each have a first, inner hollow profiled element 3 and a second, outer hollow profiled element 4 which is displaceable along its longitudinal axis 5 relative to the first hollow profiled element 3. The first inner hollow profiled element 3 in each case is connected to a castor 6 which rests on the floor. The system 1 rests on the floor with the castors 6. On an underside with which the castors 6 rest on the floor, a mechanically heavy-duty and slidable gliding layer is provided on the castors 6. This means that the system 1 can slide over the floor more easily. Damage to the sliding layer and, in particular, the castors 6 themselves is prevented. The castor 6 is fitted into the inner hollow profiled element 3 by means of an attachment element 30.

The second outer hollow profiled element 4 in each case is connected to a table leg 7 of the workbench in each case. The table legs 7 are substantially secured in corner regions on an underside of a rectangular table top 8. The table legs 7 form a basic structure of the system 1. The basic structure which is particularly connected to the table top 8 comprises further reinforcing members such as intermediate struts, intermediate bottoms and/or floor cupboards, for example. The table legs 7 are in each case second parts within the meaning of the invention. The second parts are assembled according to the exemplary embodiment shown into the basic structure. A displacement of a second part, in other words a table leg 7, simultaneously causes a displacement of the other table legs 7 and the devices 2 fastened thereto.

It is also possible for the inner hollow profiled element to be used as a second hollow profiled element and connected to a castor. In this case, the outer hollow profiled element would be a first hollow profiled element which would be connected to the basic structure of the system 1, in particular to the table legs 7 of a table in each case.

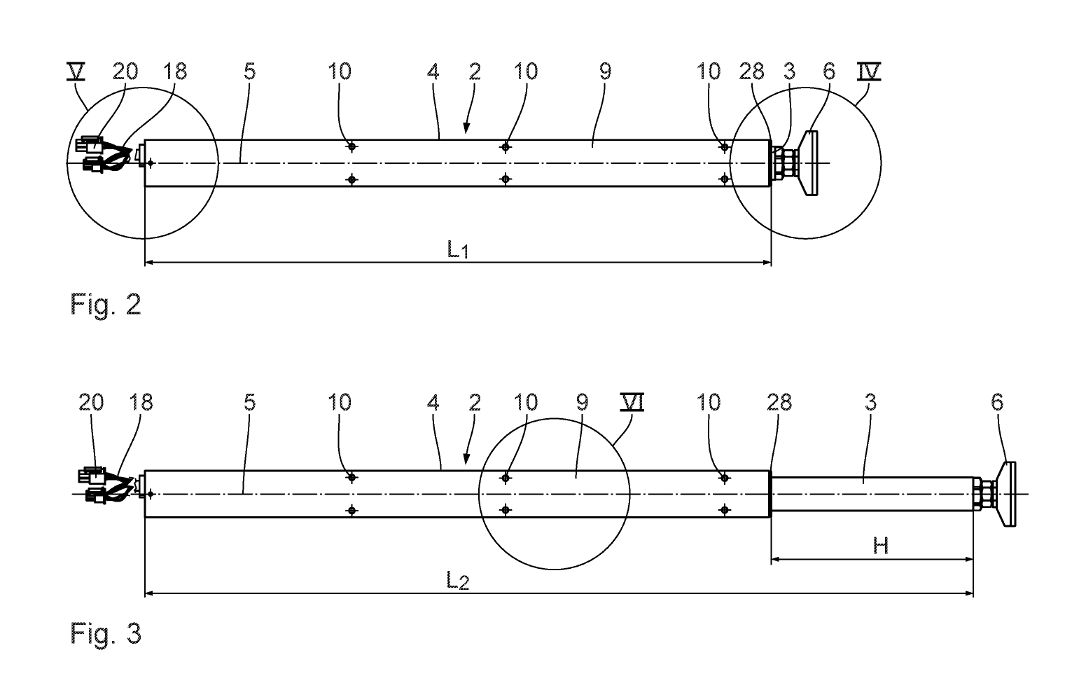

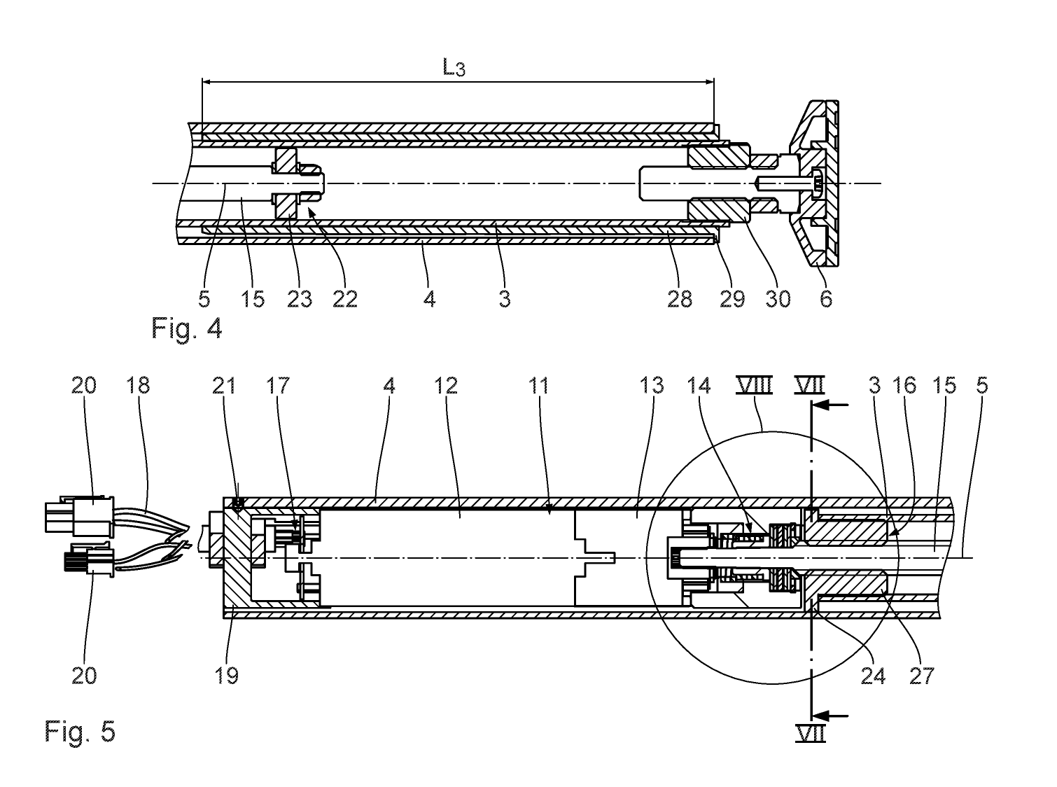

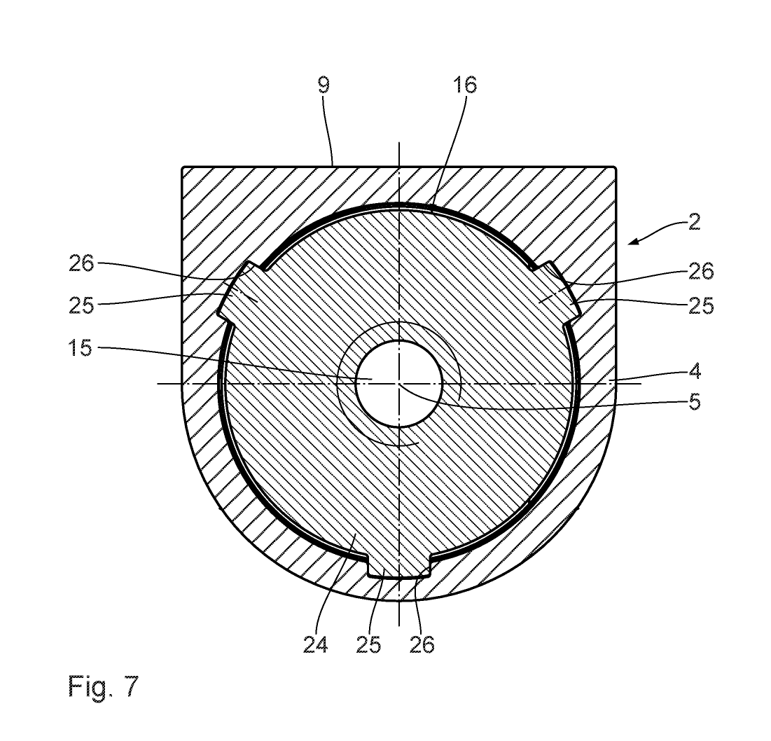

The device 2 is explained in greater detail below with the help of FIGS. 2 to 8 according to a first exemplary embodiment.

FIG. 2 shows a device 2 according to FIG. 1 in a maximum retracted state. In this state, the device 2 has a length L₁. A maximum extended state of the device 2 is shown in FIG. 3. In this state, the device 2 has a length L₂ which is greater than the length L₁. The difference in length produces the maximum travel H which is depicted in FIG. 2.

According to the exemplary embodiment shown, the outer hollow profiled element 4 exhibits a planar bearing surface 9. The bearing surface 9 exhibits a plurality of fastening bores 10. The fastening bores 10 are used to fasten the device 2 to the basic structure of the system 1, particularly to the table leg 7.

According to the exemplary embodiment shown, the outer hollow profiled element 4 is designed as a so-called CB profile. The CB profile allows quick and easy assembly by bolting or screwing to existing furniture elements, particularly to a work bench. Alternative shapes for the outer hollow profiled element 4 are also conceivable. Using a corner-leg profile, a modular configuration of a system is possible in which individual profiled elements can be connected to one another. A profiled element of this kind allows great flexibility when defining the geometry of the furniture element.

The outer hollow profiled element 4 is a housing of the device 2. It is essential for the outer hollow profiled element 4, particularly independently of the outer contour, to have a substantially cylindrical inner contour.

In the outer hollow profiled element 4 an inner hollow profiled element 3 is displaceable along the longitudinal axis 5.

For the displacement of the second hollow profiled element 4 relative to the first hollow profiled element 3, a drive unit 11 is provided which is explained in greater detail below. The drive unit 11 is arranged according to the exemplary embodiment shown proportionately in the first hollow profiled element 3 and in the second hollow profiled element 4. The drive unit 11 cannot be seen from outside the device 2, as in FIG. 2, 3 for example.

The drive unit 11 comprises a motor which is reproduced according to the exemplary embodiment shown as an electric motor 12. An encoder unit 17 is provided on the electric motor 12 turned towards a face end of the outer hollow profiled element. The encoder unit 17 may exhibit two Hall sensors, for example, which are offset to one another relative to the longitudinal axis 5 by 90°, for example, and interact with a permanent magnet fixedly arranged on the motor shaft of the electric motor 12, which permanent magnet has two poles or even multiple poles. With each revolution of the motor about the longitudinal axis 5, a pulse is determined for each Hall sensor using a two-pole permanent magnet, for example, which pulse is then further processed by a control unit which is not shown. The pulses are used by the electrical control unit, particularly for a synchronous actuation of a plurality of devices 2. In particular, it is therefore possible for individual devices 2 to be individually actuated and an asynchronous displacement to be reset, in order to guarantee, in particular, an integrally uniform linear displacement of the second part relative to the first part. Synchronization of the displacements of the devices 2 is advantageous particularly where there are different external loads on the individual devices 2. The encoder unit 17 is used for connecting electrical lines 18 to the motor 12. The electrical lines 18 are guided through a sealing cap 19 arranged on the outer hollow profiled element 4 on the face end and each provided with a plug-in member 20. By means of the sealing cap 19, the outer hollow profiled element 4 is reliably, but accessibly, closed. The sealing cap 19 is fixed by means of a set screw 21 according to the exemplary embodiment shown.

The electric motor 12 is connected via a gear 13 and a brake unit 14 to a threaded spindle 15 which interacts with a corresponding spindle nut 16. The threaded spindle 15 is fixedly connected to the gear 13 in an axial direction relative to the longitudinal axis 5. The threaded spindle 15 is connected to the gear in a rotationally fixed manner relative to rotation about the longitudinal axis 5. A rotational movement of the electric motor 12 is transferred to the gear 13 and from there straight to the threaded spindle 15. A rotational movement of the threaded spindle 15 brings about an axial displacement along the longitudinal axis 5 of the spindle nut 16. The spindle nut 16 has an internal thread for this purpose which corresponds to an external spindle thread of the threaded spindle 15. At a free end 22, the threaded spindle 15 is supported by means of a support member 23 on the inner hollow profiled element 3. The supporting member 23 is a spindle guide.

The spindle nut 16 is substantially sleeve-shaped in design. The spindle nut 16 has a plate portion 24. The plate portion 24 is arranged on the threaded spindle 15 on the face end. The plate portion 24 is integrally formed on the sleeve portion of the spindle nut 16. The plate portion 24 projects radially relative to the longitudinal axis 5 relative to the sleeve portion, at least sectionally. According to the exemplary embodiment shown, three guide bars 25 are provided along the outer periphery of the plate portion 24 of the threaded spindle 15. The guide bars 25 are spaced apart from one another evenly relative to the peripheral direction about the longitudinal axis 5, in other words spaced apart from one another at 120° in each case. The guide bars 25 mean that the spindle nut 16 has an out-of-center member contour perpendicular to the longitudinal axis 5 in the form of an out-of-center outer contour. The guide bars 25 are each housed in a corresponding guide groove 26 there and allow a guided displacement of the spindle nut 16 along the longitudinal axis 5. The guide grooves 26 attached to an inside of a curved cylinder surface of the outer hollow profiled element 4 form a holding structure which interacts with the spindle nut 16 in such a manner that a twisting of the spindle nut 16 about the longitudinal axis 5 is precluded. The spindle nut 16 forms an anti-twist protection along with the holding structure, which anti-twist protection prevents the two hollow profiled elements 3, 4 from twisting in relation to one another.

The spindle nut 16 is secured to the inner hollow profiled element 3. According to the exemplary embodiment shown, the spindle nut 16 has an external thread in the region of the sleeve portion 27 onto which the inner hollow profiled element 3 is screwed and is secured by means of a bonded joint or a mechanical pinned fitting to prevent it from untwisting again. The plate portion 24 is used at least in the region of the guide bars 25 as a stop shoulder for the annular end face of the inner hollow profiled element 3. Through the fixed connection of the spindle nut 16 to the inner hollow profiled element 3, a displacement of the spindle nut 16 automatically causes a displacement of the inner hollow profiled element 3. At a face end opposite the spindle nut 16 the castor 6 is fastened to the inner hollow profiled element 3, particularly screwed on and secured to prevent it from untwisting again.

In the device 2, the anti-twist protection is implemented by the guide grooves 26 on the inner diameter of the outer hollow profiled element 4 and by guide bars 25 of the spindle nut 16 corresponding thereto. The spindle nut 16 is fixedly connected to the inner hollow profiled element 3. The guide grooves 26 extend along the longitudinal axis 5 over the entire length of the outer hollow profiled element 4. This means that a reliable and accurate guided displacement along the entire length of the outer hollow profiled element 4 is guaranteed. Additional guide members can be dispensed with, as is known from DE 10 2010 000 970 A1, for example. The guide grooves 26 and the guide bars 25 are arranged inside the device 2. The anti-twist protection is protected inside the device 2. In particular, the anti-twist protection is arranged outside a visible range. This prevents any negative impact on the overall aesthetic effect. In addition, the guide bars 25 and the guide grooves 26 are protected from unwanted contamination. The anti-twist protection has a long-life design.

In relation to the longitudinal axis 5, a support unit 28 in the form of a guide bushing is arranged in a radial direction between the first inner hollow profiled element 3 and the second outer hollow profiled element 4. The guide bushing is inserted into the outer hollow profiled element 4 at the face end opposite the sealing cap 19. A maximum insertion depth of the guide bushing is defined by a ring stop 29. The guide bushing has a support unit length L₃ along the longitudinal axis 5 by which the support unit 28 projects into the outer hollow profiled element 4. The following applies to the dimensions of the support length L₃:L₃≈0.3·H. H results from the length difference of L₂ and L₁.

The support unit 28 along with the support member 23 ensures stable guidance and therefore allows transverse and/or radial forces to be absorbed which particularly act on the inner hollow profiled element 3. These transverse and/or radial forces are introduced onto the hollow profiled element 3 from the outside, particularly when the device 2 is assembled on the table leg 7 in a manner that is not precisely flush and due to production and component tolerance offsets. The inner hollow profiled element 3 is a guide pipe.

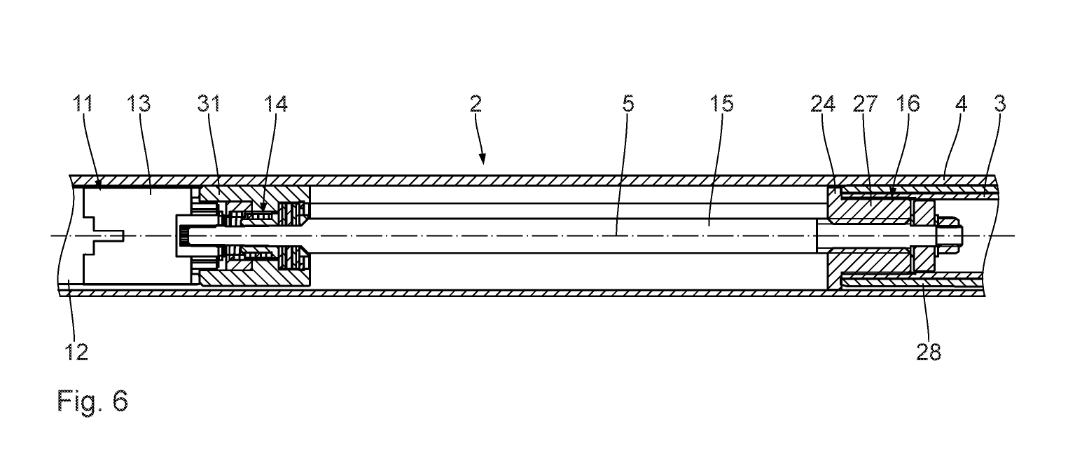

The device 2 has a bearing unit 31. The bearing unit 31 is directly connected to the outer hollow profiled element 4. The bearing unit 31 has an axial/radial bearing 32 for the threaded spindle 15. The axial/radial bearing 32 is held in the bearing unit 31 by means of a bearing safety mechanism 33 axially along the longitudinal axis 5, in other words axially fixed. Spindle axial forces that occur are supported via the axial/radial bearing 32 directly on the outer hollow profiled element 4. The support member 23 for supporting the threaded spindle 15 is provided on the inner hollow profiled element 3 at the opposite end of the threaded spindle 15. The support member 23 is simultaneously used as an axial stop member and therefore as a limit for travel in the extension direction for the inner hollow profiled element 3. This arrangement is depicted in FIG. 6.

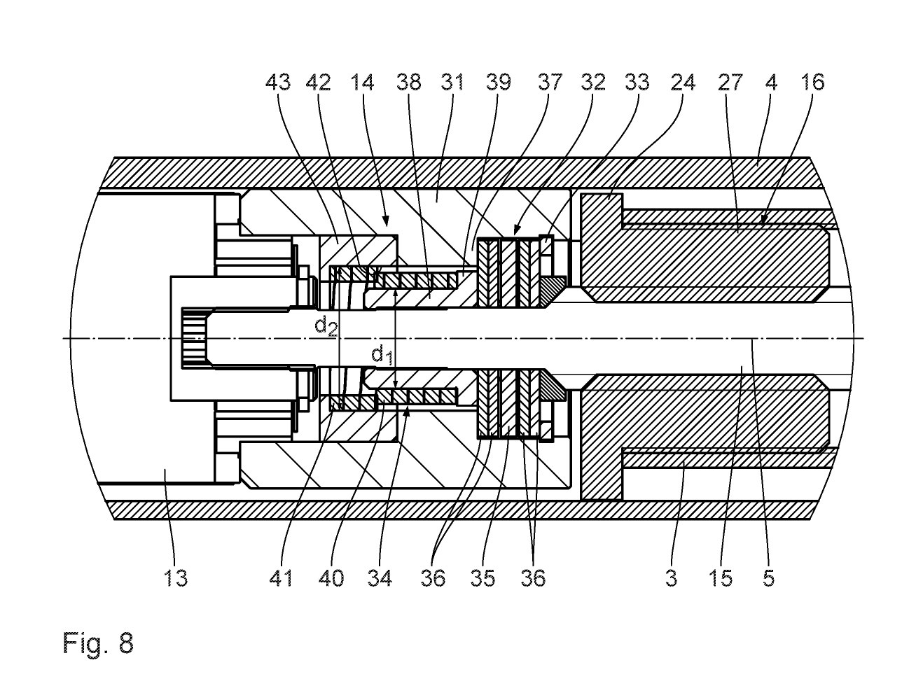

The axial/radial bearing comprises an axial bearing collar 35 and bearing washers 36 arranged along the longitudinal axis 5 on both sides on the axial bearing collar 35. The bearing washers 36 depicted on the left in FIG. 8 are supported at the end face on a shoulder 37 of the bearing unit 31. Axial tensile forces which act to the right according to FIG. 8, in other words in the direction of the spindle nut 16, are introduced by the threaded spindle 15 onto the pressing sleeve 38 fixedly attached thereto. The pressing sleeve 38 has a coil 39 by means of which the aforementioned axial tensile forces are transferred to the axial/radial bearing. The bearing washers 36 support the forces introduced via the bearing safety mechanism 33 to the bearing unit 31.

A first embodiment of the brake unit 14 is explained in greater detail below with the help of FIG. 8. The first brake unit 14 comprises a coil spring 34.

As already explained above, the brake unit 14 works in a manner depending on the direction of rotation.

The brake unit 14 with the coil spring 34 is used to generate an additional frictional torque during a rotational movement of the threaded spindle 15 about the longitudinal axis 5. The coil spring 34 is a spring member in which the spring wire is wound cylindrically in relation to a rotational axis of the coil spring 34. According to the exemplary embodiment shown, the spring wire has a rectangular, particularly square, cross section. The coil spring 34 is arranged with the rotational axis concentrically to the longitudinal axis 5 of the device 2. The coil spring 34 is housed in the bearing unit 31.

The coil spring 34 has a first cylinder portion 40 which faces the pressing sleeve 38. The first cylinder portion 40 has a first internal diameter d₁. The first internal diameter d₁ is selected in such a manner that the coil spring 34 with the first cylinder portion 40 is frictionally connected to the pressing sleeve 38. The coil spring 34 with the first cylinder portion 40 with the curved cylindrically shaped inner face thereof bears against a cylindrical outer face of the pressing sleeve 38. The coil spring 34 is fastened with the first cylinder portion 40 to the pressing sleeve 38. The coil spring 34 is connected in a torque-transferring manner to the threaded spindle 15.

At an end of the coil spring 34 opposite the first cylinder portion 40 is arranged a second cylinder portion 41. The second cylinder portion 41 has a second diameter d₂ which is greater than the first internal diameter d₁. Accordingly, a corresponding outer diameter of the second cylinder portion 41 is greater than a first outer diameter of the first cylinder portion 40. The second cylinder portion 41 of the coil spring 34 is brought into engagement with its outer cylinder face at an inner face 42 of a frictional sleeve 43. The frictional sleeve 43 is fixedly arranged in the bearing unit 31 by an interference fit.

Depending on the diameter ratios, in other words particularly the ratio of the first inner diameter d₁ of the first cylinder portion 40 to the outer diameter d₂ of the pressing sleeve 38 and/or the ratio of the outer diameter of the second cylinder portion 41 and an inner diameter of the frictional sleeve 43, the local, in particular radially acting, pretensions on the coil spring 34 in the bearing unit 31 can be influenced. Depending on a spring pretension, differently acting frictional moments, in other words braking effects, can be selectively caused. The frictional moments are, in addition, also dependent on the material pairings selected, in other words particularly the materials specified for the pressing sleeve 38, the frictional sleeve 43 and the coil spring 34. Depending on the rotational direction of the threaded spindle 15 about the longitudinal axis 5, a frictional moment acts either between the first cylinder portion 40 and the pressing sleeve 38 or between the second cylinder portion 41 and the frictional sleeve 43. It is therefore possible for different frictional moments to be set, depending on the rotational direction of the threaded spindle 15.

The coil spring 34 is of integral design. The cylinder portions 40, 41 are connected to one another integrally. The coil spring 34 is coherently produced from a winding wire. The coil spring 34 is wound in the first cylinder portion 40 with a first diameter which is smaller than a second diameter in the second cylinder portion 41.

The function of a device 2 according to the invention is explained in greater detail below. To adjust the height of the system 1, the four devices 2 are activated. A switch not depicted in greater detail is used for this, which switch may be arranged on an underside of the table top 8, for example. The control unit not depicted in greater detail is actuated via the switch, said control unit being connected to the device 2 via the plug 20 and the electric cable 18. The control unit causes a rotational movement of the electric motor 12. This rotational movement is directly transferred to the threaded spindle 15 via the gear 13. The rotational movement of the threaded spindle 15 causes an axial displacement of the spindle nut 16 along the longitudinal axis 5. The inner hollow profiled element 3 is displaced with the spindle nut 16 along the longitudinal axis 5. Due to the anti-twist protection, it is guaranteed that unwanted twisting of the hollow profiled elements 3, 4 is prevented. The outer hollow profiled element 4 is fixedly attached to the table leg 7 in each case.

Due to the extension movement of the device 2, the coil spring 34 is held due to a greater interference fit with the second cylinder portion 41 on the frictional sleeve 43. In addition, the coil spring 34 then rubs with the first cylinder portion 40 due to a smaller interference fit on the pressing sleeve 38. This extension movement of the device 2 is caused by the rotational direction of the threaded spindle 15. The rotational direction of the threaded spindle 15 depends on the orientation of the spindle thread, so on whether a left-handed or right-handed thread is provided on the threaded spindle 15. It is essential for the winding direction of the coil spring 34 to be opposite the rotational direction of the threaded spindle 15 in the extension movement. It is established in accordance with the winding direction of the spring wire of the coil spring 34 that the first cylinder portion 40 wears through on the pressing sleeve during the rotational extension movement and the second cylinder portion 41 is held on the frictional sleeve 43 due to the greater interference fit.

Due to the insertion movement of the device 2, the threaded spindle 15 then turns in the coil spring winding direction, so that the coil spring 34 at the first cylinder portion 40 firmly loops at the pressing sleeve 38 and the coil spring 34 therefore rotates with the threaded spindle 15. In addition, the coil spring 34 then rubs with the second cylinder portion 41 after overcoming a greater frictional torque at the frictional sleeve 43. Firmly looping means that due to the application of torque to the coil spring 34, the diameter thereof widens or narrows, so particularly the inner diameter and the outer diameter of the cylinder portion 40, 41 in each case, and the coil spring 34 therefore loops firmly at the respective counterpart. Accordingly, wearing through means that the inner and outer diameters of the cylinder portions 40, 41 in each case change relative to the counterpart in each case, such that the coil spring 34 wears through at the respective counterpart from a certain torque.

In relation to the dependence of the braking action of the brake unit 14 with the coil spring 34 on the direction of rotation, the diameters, including the tolerances thereof, of the two cylinder portions 40, 41, of the pressing sleeve 38 and of the frictional sleeve 43 are crucial. So that during an extension movement of the inner hollow profiled element 3 a reduced braking torque, in particular a significantly smaller braking torque than with an insertion movement, is possible, a pressing of the first inner diameter d₁ of the coil spring 34 with the first cylinder portion 40 onto the pressing sleeve 38 is significantly smaller than a pressing of the second diameter d₂ of the coil spring 34 onto the frictional sleeve 43. The pressing results from the differences in diameter, in other words particularly the first inner diameter d₁ of the first cylinder portion 40 and an outer diameter of the pressing sleeve 38 or the second diameter d₂ and the inner diameter of the frictional sleeve 43. The pressing is all the greater, the greater the difference in diameter. For example, the first inner diameter d₁ of the coil spring 34 in the unmounted state is 0.2 mm smaller than the outer diameter of the pressing sleeve 38. In this case, there is a small overlap at best. The second outer diameter d₂ of the coil spring 34 is 0.8 mm greater in the unmounted state than the inner diameter of the frictional sleeve 43. Between the second cylinder portion 41 and the frictional sleeve 43 lies a comparatively larger overlap. This more or less large material overlap in the mounted state guarantees different frictional torques when the spindles are rotating in different directions. These frictional torques which are to be achieved are additionally influenced by a different choice of material for the frictional sleeve 43, the pressing sleeve 38 and the coil spring 34 and also by the surface qualities thereof. Since this braking unit 14 is based on friction and is therefore liable to wear in the long-term, the friction partners must also be designed for this. It may therefore be necessary, for example, for the pressing sleeve 38 and the frictional sleeve 43 to be produced from hardened steel and defined surface roughnesses.

The extension of the inner hollow profiled element 3 relative to the outer hollow profiled element 4 takes place in a stable and particularly supported manner. The threaded spindle 15 is on the one hand mounted in the bearing unit 31. In addition, the support member 23 is provided at the free end of the threaded spindle 15 as the spindle guide. Forces introduced from the inner hollow profiled element 3 which act transversely and particularly perpendicularly to the longitudinal axis 5 are transferred directly to the support unit 28 in the form of the guide bushing.

The extension of the inner hollow profiled element 3 of the device 2 causes a lifting of the entire system 1, in other words, the table with the table legs 7 and the table top 8 arranged thereon.

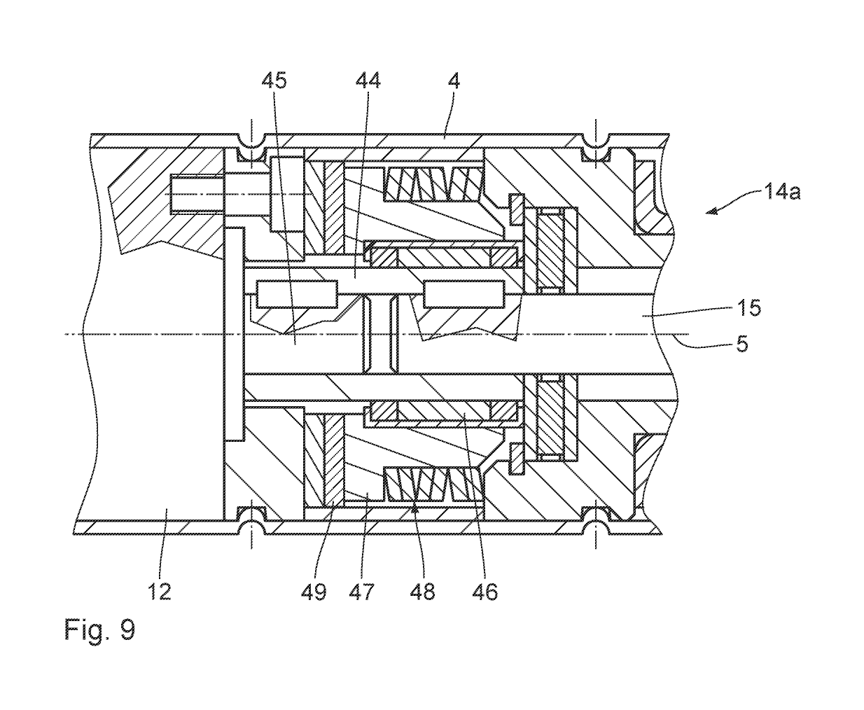

In the following, a second exemplary embodiment of a braking unit is described with reference to FIG. 9. Structurally identical parts have the same reference numbers as in the first exemplary embodiment, the description whereof being referred to here. Structurally different but functionally identical parts are given the same reference number with an “a” added at the end.

The braking unit 14a likewise acts in a manner depending on the direction of rotation. The braking unit 14a has a connection sleeve 44 which connects an output shaft 45 of the electric motor 12 to the threaded spindle 15. On an outer curved cylinder surface of the connecting sleeve 44 a free-wheel 46 is arranged and connected to a frictional slave 47. The frictional slave 47 is pressed by a spring member 48 at the face end on a disc-shaped friction lining 49, thereby generating a frictional force. The greater the spring force acting in the axial direction, the greater the frictional torque too.

The freewheel 46 means that only a rotational movement in a previously defined rotational direction about the longitudinal axis 5 is transferred from the threaded spindle 15 and the connection sleeve 44 to the frictional slave 47. This means that a braking action does not take place in the opposite rotational direction. The braking unit 14a acts in a manner depending on the rotational direction.

A braking unit of this kind is known in principle from DE 10 2008 061 117 A1, to which reference is made for further details of the structural design and function of the braking unit. Surprisingly, it was found that this braking unit 14a with freewheel 46 can be advantageously used for the device according to the invention.

It is conceivable in principle for the braking unit 14a to be configured to act independently of the direction of rotation, so that the braking action in both rotational directions about the longitudinal axis 5 is identical. For this purpose, the frictional slave 47 without the freewheel 46 is directly connected to the connection sleeve 44, so that each rotational movement of the threaded spindle 15 causes a rotation of the frictional slave 47 and therefore a frictional torque at the friction lining 49.

While specific embodiments of the invention have been shown and described in detail to illustrate the application of the principles of the invention, it will be understood that the invention may be embodied otherwise without departing from such principles.

1. A device for adjusting a height of a first part relative to a second part, the device comprising:
a first hollow profiled element;
a second hollow profiled element comprising a second hollow profiled element longitudinal axis, the second hollow profiled element being displaceable along the second hollow profiled element longitudinal axis relative to the first hollow profiled element;
a drive unit for displacement of the second hollow profiled element relative to the first hollow profiled element;
a support unit for supporting the first hollow profiled element against the second hollow profiled element, the support unit being arranged between the first hollow profiled element and the second hollow profiled element relative to the second hollow profiled element longitudinal axis.

2. A device according to claim 1, wherein the drive unit has a motor.

3. A device according to claim 1, wherein the drive unit has a gear.

4. A device according to claim 1, wherein the drive unit has a threaded spindle and a spindle nut corresponding to the threaded spindle.

5. A device according to claim 1, further comprising:
a braking unit.

6. A device according to claim 1, further comprising:
an anti-twist protection to prevent the second hollow profiled element from twisting relative to the first hollow profiled element about the second hollow profiled element longitudinal axis.

7. A device according to claim 6, wherein the anti-twist protection has a displaceable member which is displaceable along the second hollow profiled element longitudinal axis.

8. A device according to claim 7, wherein the displaceable member comprises a member contour, the member contour comprising at least one radially projecting guide bar relative to the second hollow profiled element longitudinal axis, the displaceable member interacting with a holding structure, the holding structure having a holding structure contour, the holding structure contour comprising a guide groove corresponding to the at least one radially projecting guide bar.

9. A device according to claim 1, wherein the support unit has a guide bushing which is fastened to the second hollow profiled element.

10. A device according to claim 1, wherein the support unit acts as an axial stop member for displacement of the first hollow profiled element relative to the second hollow profiled element.

11. A device according to claim 1, further comprising:
an encoder unit.

12. A device according to claim 1, further comprising:
a storage unit for absorbing forces directed in at least one of a radial direction and an axial direction relative to the second hollow profiled element longitudinal axis.

13. A retrofit kit for a device according to claim 1, the retrofit kit comprising:
a drive unit adapted to be arranged in at least one of the first hollow profiled element and the second hollow profiled element for displacing the second hollow profiled element relative to the first hollow profiled element; and
a support unit adapted to be arranged between the first hollow profiled element and the second hollow profiled element relative to the second hollow profiled element longitudinal axis.

14. A height-adjustable system comprising:
at least a first part;
at least a second part height-adjustable relative to the first part;
at least one device for height adjustment of the at least the first part in each case relative to the at least the second part in each case, the at least one device comprising a first hollow profiled element, a second hollow profiled element, a drive unit for displacement of the second hollow profiled element relative to the first hollow profiled element and a support unit for supporting the first hollow profiled element against the second hollow profiled element, the second hollow profiled element comprising a second hollow profiled element longitudinal axis, the second hollow profiled element being displaceable along the second hollow profiled element longitudinal axis relative to the first hollow profiled element, the support unit being arranged between the first hollow profiled element and the second hollow profiled element relative to the second hollow profiled element longitudinal axis, wherein the first hollow profiled element of the at least one device is connected to the first part, wherein the second hollow profiled element of the at least one device is connected to the second part.

15. A height-adjustable system according to claim 14, further comprising:
a control unit for controlling drive units for a linear height adjustment of the system.

16. A device according to claim 2, wherein the motor is an electric motor.

17. A device according to claim 5, wherein the braking unit is active in a manner dependent on a rotational direction.

18. A device according to claim 7, wherein the displaceable member is a spindle nut with an out-of-center member contour perpendicular to the second hollow profiled element longitudinal axis

19. A device according to claim 18, wherein the displaceable member interacts with a holding structure, the holding structure comprising a holding structure contour, the holding structure contour corresponding to the out-of-center member contour.

20. A device according to claim 18, wherein the holding structure is the second hollow profiled element.

21. A device according to claim 9, wherein the guide bushing is fastened to the second hollow profiled element at a face end.

22. A device according to claim 11, wherein the encoder unit serves for electrical connection of the drive unit.

23. A device according to claim 12, wherein said absorbing forces are introduced by the drive unit.
